(19) United States
(12) Patent Application Publication
(10) Pub. No.: US 2010/0101481 A1
(43) Pub. Date: Apr. 29, 2010

(54) Bird repeller

(76) Inventor: David Joseph Delia, Annapolis, MD (US)

Correspondence Address: David J. Delia, 1375 Walnut Avenue, Annapolis, MD, 21403, US

(21) Appl. No.: 12/584,808

(22) Filed: Sep. 11, 2009

Related U.S. Application Data
(60) Provisional application No. 61/192,075, filed on Sep. 15, 2008.

(51) Int. Cl. A01M 29/00

(52) U.S. Cl. 116/22 A

(57) ABSTRACT

A bird repeller for birds such as seagulls utilizes an array of streamers made of flexible strips configured of ribbons folded double to form anchor locations. The free ends of the strips flutter downstream in the wind as the intermediate portions undulates to discourage birds that land into the wind from landing on structures such as piers, boats, or buildings. The array of streamers is coupled by swiveling and pivoting couplings to a flexible supporting rod that holds the array of streamers aloft.

### BACKGROUND OF INVENTION

Birds such as, but not limited to, seagulls foul structures such as piers, boats and buildings with their droppings. Numerous methods and devices have been devised for repelling birds from these structures; however, they have proved either ineffective or expensive.

### SUMMARY OF THE INVENTION

Birds such as, but not limited to, seagulls are repelled from structures such as piers, boats and buildings using an array of streamers which are swiveled and pivoted on a support. Many species of birds prefer to land into the wind. In accordance with the present invention, the array of streamers is blown by the wind toward the birds as they attempt to land. The birds observe the fluttering and undulating streamers and are discouraged from landing into them.

In a preferable embodiment of the invention, the support is a flexible rod and the swivel supporting the array of streamers pivots and/or swivels with respect to the axis of the rod and swivels with respect to an axis generally aligned with the direction of the wind.

The repeller has performed effectively with the swivel attached to a coupler that is pivoted at a location adjacent to the end of the rod.

### BRIEF DESCRIPTION OF THE DRAWINGS

FIG. 1 is a perspective view of seagull repellers configured according to the present invention mounted on a pier or dock;

FIG. 2 is a perspective drawing of a seagull repeller mounted on a piling;

FIG. 3 is a front view of a mounting arrangement for a supporting rod; FIG. 4 is a perspective view of a first embodiment of an arrangement for coupling ribbons to the supporting rod, and

FIG. 5 is a perspective view of a second embodiment of an arrangement for coupling ribbons to the supporting rod.

### DETAILED DESCRIPTION

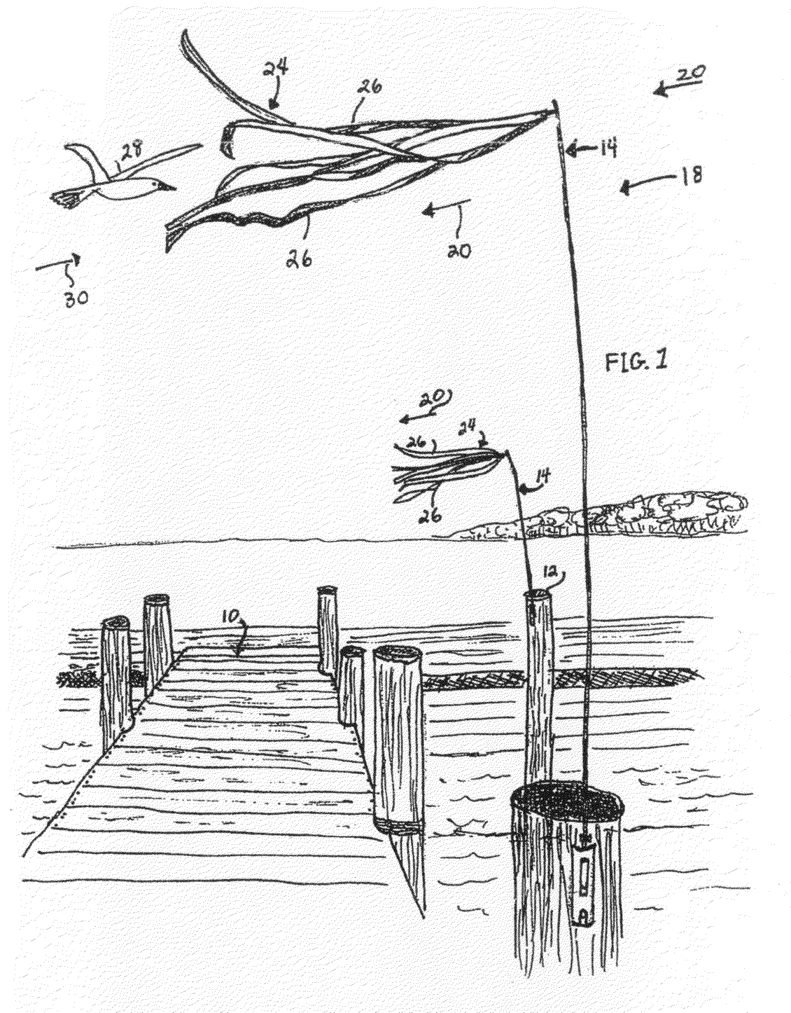

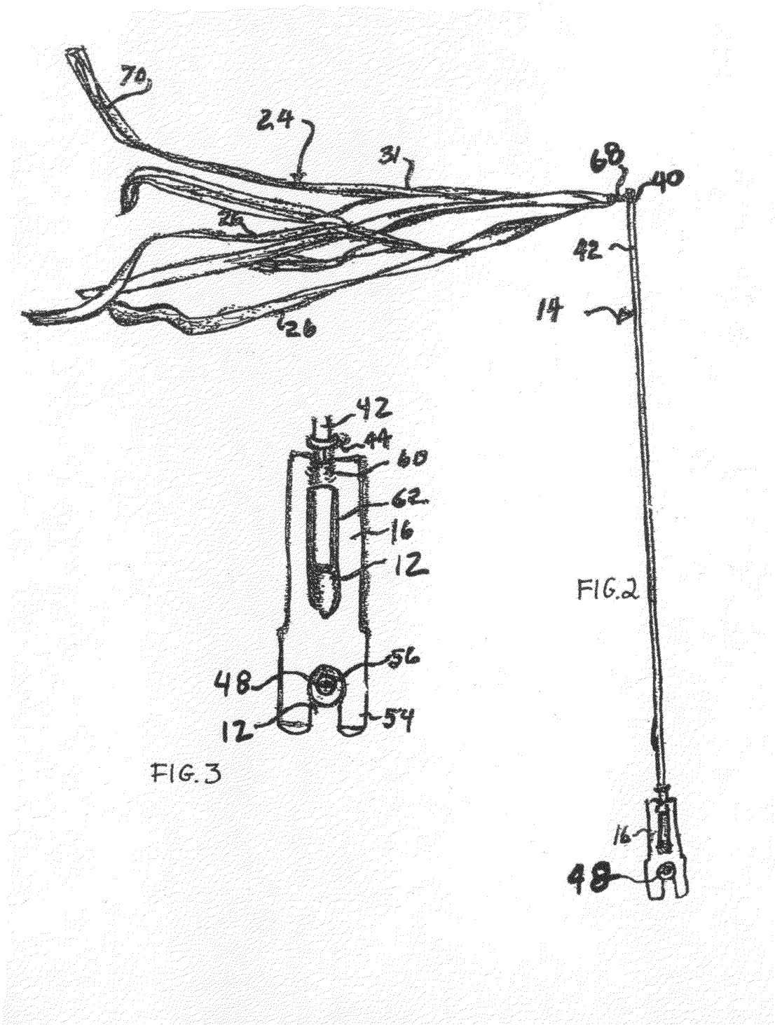

Referring now to FIG. 1, a pier or dock 10 has pilings 12 with bird repellers 14 mounted thereon using brackets 16. In FIGS. 1 and 2 the wind 18 is blowing from the direction of arrow 20 causing an array of streamers 24 of flexible ribbons 26 to extend in the direction of arrow 20. Birds such as seagulls 28 land into the wind 18 in the direction of arrow 30 so as to have a higher air speed, and thus a lower ground speed, with respect to the pier or dock 10. Upon attempting to land, the gulls are faced with a fluttering, undulating array of streamers 24 which is an experience the gulls find undesirable. Consequently, the gulls 28 will not land on the pier 10 because they are predisposed to land into the wind (in the direction of arrow 30) and not with the wind (in the direction of arrow 20). Since gulls apparently prefer to relieve themselves while perched, the pier 10 remains remarkably free of guano because the gulls land elsewhere. As seen in FIG. 2, the array of streamers 24 comprised of the ribbons 26 are preferably mounted at the free end 40 of rod 42. The rod 42 is made of flexible plastic material such as, but not limited to the material or materials, from which the rods supporting safety flags for bikes are configured.

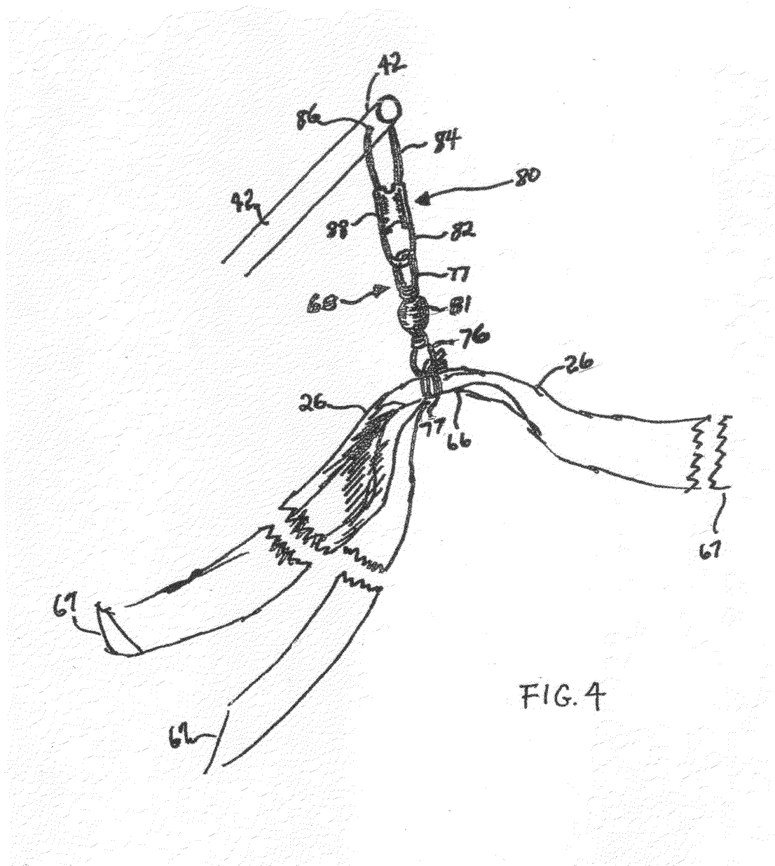

As seen in FIG. 3, the bracket 16 supporting the rod 42 can be, but is not limited to the bracket used to mount a bicycle flag rod and is in conjunction with one or more U-shaped nails 44 that are hammered into a piling 12 or other pier or building structure. A screw 48 through a slot 52 at the lower end 54 of the bracket 16 in concert with a washer 56 keeps the bracket firmly held on the piling 12. Since the rod 42 is held rigid with respect to the bracket 16 by being retained in longitudinal, opposed grooves 60, 62 and 64 upset in the bracket, the rod 42 is firmly anchored by the U-shaped nail 44 and screw 48 to the piling 12.

As seen in FIG. 4, the ribbons 26 comprising the streamers 24 are preferably each formed by anchoring individual strips 65 of a flexible material such as Mylar midway 66 their free ends 67 to a swivel arrangement 68. Several strips 65 of flexible material 70 are used to make each streamer 24. One embodiment uses four strips 65 to form eight ribbons 26. In a preferred embodiment, the four strips 65 are each eight feet long providing eight four foot ribbons 26, each having a width of about one inch. Preferably, the ribbons 26, each have reflective front and rear surfaces having surface patterns of lateral stripes. Preferably, the surfaces of the ribbons are silver in color. The strips 65 are bunched and tied with a coated metal tie wire 71 looped and twist tied to the swivel arrangement 68.

As is further seen in FIG. 4, the swivel arrangement 68 is a fishing line snapswivel 75 having a pair of loops 76 and 77 made of stiff wire. The lops 76 and 77 are joined to a universal bead 81 so as to both pivot and swivel with respect to the bead. The loop 76 is attached to one of the streamers 24 by the metal tie wire 71, while the loop 77 is attached to a wire coupler 80. In a preferred embodiment, the wire coupler 80 is a fishing line coupler having a first resilient wire loop 82 that receives the loop 77 of the snap swivel arrangement 68 and a second resilient wire loop 84 that is passed through a hole 86 bored through the rod 42 so that the wire coupler 80 pivots with respect to the rod. The first and second resilient wire loops 82 and 84 of the wire coupler 80 are retained by a clasp 88.

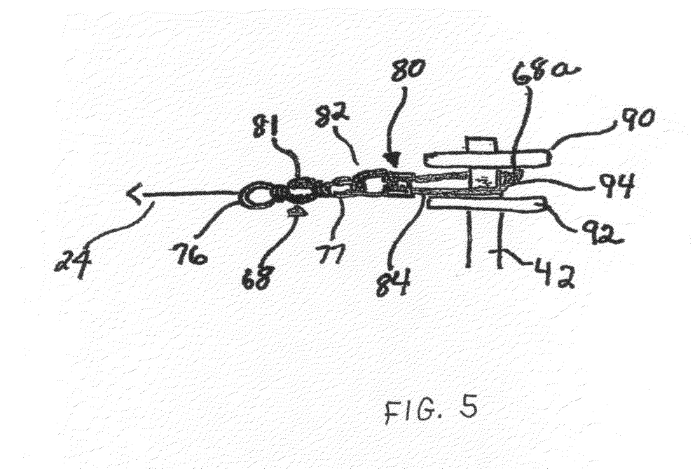

FIG. 5 shows another embodiment of the swivel arrangement, swivel arrangement 68a, wherein the second resilient wire loop 84 of the wire coupler 80 is retained on the rod 42 between a pair of projections, such as, disks 90 and 92, separated by a space 94. This allows the swivel arrangement 68a to rotate around the longitudinal axis 96 of the rod 42 lessening the likelihood that the ribbons will wrap around the rod 42. The bird repeller 14 is mounted to swivel, pivot and flex, or additionally to rotate with respect to the rod 42 so as to align with the direction 20 of the wind 18, see FIG. 1.

I claim:

1) A bird repeller comprising: an array of streamers wherein the streamers are made of flexible strips, each strip having a free end and an intermediate portion extending from an anchored portion to the free end, wherein when the wind blows each strip is lifted and extends from the anchored end, the free end fluttering in the wind as the intermediate portion undulates, thus discouraging birds that land into the wind from landing near the array of streamers, and a support to which the anchored ends of the strips are connected by a coupler, the support holding the array of streamers aloft so that the streamers are exposed to the wind.

2) The bird repeller of claim 1 wherein the coupler includes a swivel so that as the streamers flutter and undulate the array of streamers is also capable of rotating.

3) The bird repeller of claim 2 wherein the coupler further includes a pivot allowing the array of streamers to rise and fall with respect to the coupler.

4) The bird repeller of claim 1 wherein the coupler further includes a pivot allowing the array of streamers to rise and fall with respect to the coupler.

5) The bird repeller of claim 1 wherein the support is a rod having a mounting end for anchoring the rod to hold aloft a free end of the rod to which the array of streamers are coupled.

6) The bird repeller of claim 5 wherein the rod is flexible.

7) The bird repeller of claim 6 wherein the coupler is further comprised of a wire loop passed through a hole in the rod at the free end of the rod.

8) The bird repeller of claim 6 wherein the coupler is further comprised of a loop received in a space between a pair of projections.

9) The bird repeller of claim 6 wherein the strips comprising the array of streamers are configured from ribbons, each ribbon being doubled into two strips with the anchor portions of the strips being midway between free ends of the ribbons.

10) The bird repeller of claim 9 wherein the ribbons are made of a reflective plastic material.

11) The bird repeller of claim 10 wherein the plastic material is Mylar.

12) The bird repeller of claim 1 wherein the strips comprising the array of streamers are configured from ribbons, each ribbon being doubled into two strips with the anchor portions of the strips being midway between free ends of the ribbons.

13) The bird repeller of claim 12 wherein the ribbons are made of a reflective plastic material.

14) The bird repeller of claim 13 wherein the plastic material is Mylar.
